(19) United States
(12) Patent Application Publication
(10) Pub. No.: US 2021/0279660 A1
(43) Pub. Date: Sep. 9, 2021

(54) INFORMATION SHARING ASSISTANCE METHOD AND INFORMATION SHARING ASSISTANCE SYSTEM

(71) Applicant: HITACHI, LTD., Tokyo (JP)

(72) Inventors: Jun NAKAJIMA, Tokyo (JP); Yoji OZAWA, Tokyo (JP); Zhihui LU, Shanghai (CN); Jie WU, Shanghai (CN); Jian YANG, Shanghai (CN); Ming CHAI, Shanghai (CN); Junxiong LIN, Shanghai (CN)

(21) Appl. No.: 17/184,728

(22) Filed: Feb. 25, 2021

(30) Foreign Application Priority Data
Mar. 6, 2020 (JP) 2020-039017

(51) Int. Cl. G06Q 10/06

(52) U.S. Cl. CPC G06Q 10/06313; G06Q 10/0633

(57) ABSTRACT

An information processing device executes a request reception process in which a plurality of predetermined requests are received, the plurality of predetermined requests being related to predetermined information for an information processing system in which the predetermined information is shared by a plurality of nodes that can communicate with each other, an integration management process in which the plurality of received requests are converted and integrated into a format that can be handled by each node of the information processing system according to a predetermined rule and thus a new request is created, and a request process in which the new request is transmitted to the information processing system to process the predetermined request at each node of the information processing system.

### CROSS-REFERENCE TO RELATED APPLICATION

This application claims priority pursuant to Japanese patent application No. 2020-039017, filed on Mar. 6, 2020, the entire disclosure of which is incorporated herein by reference.

### BACKGROUND

### Technical Field

The present invention relates to an information sharing assistance method and an information sharing assistance system.

### Related Art

A technology has emerged that replaces transactions between users, which have been carried out via reliable centralized institutions such as financial institutions and governments, with direct transactions between users by P2P (Peer to Peer). This is a distributed ledger technology using a blockchain (hereinafter, also referred to as BC).

The main features of the distributed ledger technology are as follows: (1) in transactions between participants of the distributed ledger system, the transaction is finalized by consensus building or approval by the participants (voluntary or specific) rather than the centralized authority; (2) a plurality of transactions are grouped into blocks, these blocks are recorded in a distributed ledger called a blockchain, and tampering is substantially impossible by performing hash calculation on consecutive blocks; and (3) by sharing the same distributed ledger with all participants, it is possible for all participants to confirm transactions.

In addition, a smart contract (hereinafter, also referred to as SC) has been proposed as an application example of the distributed ledger technology. SC makes it possible to apply distributed ledger technology to complex transaction conditions and various applications. As a result, logic that considers not only transaction data but also transaction conditions is formed. As a conventional technique for SC, there has been proposed a technique for a distributed ledger platform having an execution function of SC (see “Ethereum White Paper” ([online], [Search on Dec. 23, 2019], Internet <URL: https://github.com/ethereum/wiki/wiki/White-Paper>) and “Hyperledger Fabric” ([online], [Searched on Dec. 23, 2019], Internet <URL: http: //hyperledger-fabric.readthedocs.io/en/latest/>)).

Further, as an application example of the distributed ledger technology, a so-called consortium type distributed ledger platform has also been proposed. In this distributed ledger infrastructure, only computers authorized by a specific group or person, such as a consortium in a specific industry or multiple companies involved in the supply chain, are the approver of the transaction. In such a consortium type distributed ledger platform, there is a management entity that selects an approver, so there is an advantage that the speed of transaction approval can be accelerated.

In the various distributed ledger infrastructures that have evolved in this way, each node accepts a transaction (hereinafter, also referred to as TX) while forming a predetermined level of agreement regarding TX, executes the TX, and holds an execution result of the TX so that the plurality of nodes share information (ledger) related to the TX. In addition, each node may have an SC execution function that executes predetermined logic for TX.

As the application of BC technology progresses in various industries and usage scenes in this way, it is becoming necessary for blockchain systems to meet performance requirements related to commercial transactions at a realistic level, and a technology that aims to improve this performance (see “Accelerating Throughput in Permissioned Blockchain Networks” ([Searched on Dec. 23, 2019], Internet <URL: https://www.samsungsds.com/us/en/solutions/bns/Blockchain/Blockchain.html>)) has been proposed. In the technique of “Accelerating Throughput in Permissioned Blockchain Networks”, it is disclosed that a plurality of requests are collectively transmitted to BC and an attempt is made to improve performance by parallelizing consensus building processing in BC.

However, when commerce becomes active and a large amount of stream data is handled, improving the performance (throughput performance) of the entire commerce becomes a more serious issue.

In this regard, according to the technique of “Accelerating Throughput in Permissioned Blockchain Networks”, it is expected that the performance of the consensus building process in BC will be improved. However, in BC, it is necessary to ensure the matching of the states of the nodes of each organization by a mechanism of writing in series, and this writing performance greatly affects the throughput performance. However, in “Accelerating Throughput in Permissioned Blockchain Networks”, the write process in BC is performed in series after uniquely determining the execution order. Therefore, in the technology of “Accelerating Throughput in Permissioned Blockchain Networks”, it cannot be expected that the improvement of the write processing performance, which is important for the improvement of throughput performance, is achieved.

### SUMMARY

The invention has been made in view of such a current situation, and an object thereof is to provide an information sharing assistance method and an information sharing assistance system capable of improving the throughput performance of communication related to information sharing (for example, performance related to a consensus building process and a writing process).

One aspect of the invention for solving the above-mentioned problems is an information sharing assistance method, executed by an information processing device, which includes a request reception process in which a plurality of predetermined requests are received, the plurality of predetermined requests being related to predetermined information to an information processing system in which the predetermined information is shared by a plurality of nodes that can communicate with each other, an integration management process in which the plurality of received requests are converted and integrated into a format that can be handled by each node of the information processing system according to a predetermined rule and thus a new request is created, and a request process in which the new request is transmitted to the information processing system to process the predetermined request at each node of the information processing system.

Another aspect of the invention for solving the above-mentioned problems is an information sharing assistance system which includes an arithmetic device. The arithmetic device executes a request reception process in which a plurality of predetermined requests are received, the plurality of predetermined requests being related to predetermined information to an information processing system in which the predetermined information is shared by a plurality of nodes that can communicate with each other, an integration management process in which the plurality of received requests are converted and integrated into a format that can be handled by each node of the information processing system according to a predetermined rule and thus a new request is created, and a request process in which the new request is transmitted to the information processing system to process the predetermined request at each node of the information processing system.

According to the invention, it is possible to improve the throughput performance of communication related to information sharing.

Objects, configurations, and effects besides the above description will be apparent through the explanation on the following embodiments.

### BRIEF DESCRIPTION OF THE DRAWINGS

FIG. 1 is a diagram for explaining an example of a configuration of an information sharing assistance system according to a first embodiment;

FIG. 2 is a diagram illustrating an example of an integration condition table;

FIG. 3 is a diagram illustrating an example of an integration policy table;

FIG. 4 is a diagram illustrating an example of an integration rule table;

FIG. 5 is a diagram illustrating an example of a key mapping table;

FIG. 6 is a diagram for explaining an example of functions provided by a client node;

FIG. 7 is a diagram for explaining an example of functions provided by a member management node;

FIG. 8 is a diagram for explaining an example of functions provided by a distributed ledger node;

FIG. 9 is a diagram for explaining an example of hardware provided in each information processing device in the information sharing assistance system;

FIG. 10 is a flowchart for explaining an outline of an information sharing assistance process;

FIG. 11 is a flowchart for explaining an example of an integration necessity determination process;

FIG. 12 is a flowchart for explaining an example of a request analysis process;

FIG. 13 is a flowchart for explaining an example of a request integration process;

FIG. 14 is a flowchart for explaining an example of a request conversion process; and

FIG. 15 is a diagram illustrating an example of a configuration of an information sharing assistance system according to a second embodiment.

### DESCRIPTION OF EMBODIMENTS

Hereinafter, embodiments of the invention will be described with reference to the accompanying drawings. Further, the embodiments described below do not limit the scope of the invention. Not all the elements and combinations thereof described in the embodiments are essential to the solution of the invention. In each drawing, the same reference numerals indicate the same components throughout the drawings.

In the present specification, when explaining that the information processing device executes a module or a program, the description may be given with the module or the program as the subject.

Further, in the present specification, the contents of data may be described by terms such as “aaa table” or “aaa database”, but these are not intended to limit the data structure. Therefore, it is sometimes called “aaa information” to indicate this. Similarly, the terms “identification information”, “identifier”, “name”, and “ID” all mean information for identifying a certain object, and their meanings are the same.

### First Embodiment

### <System Configuration>

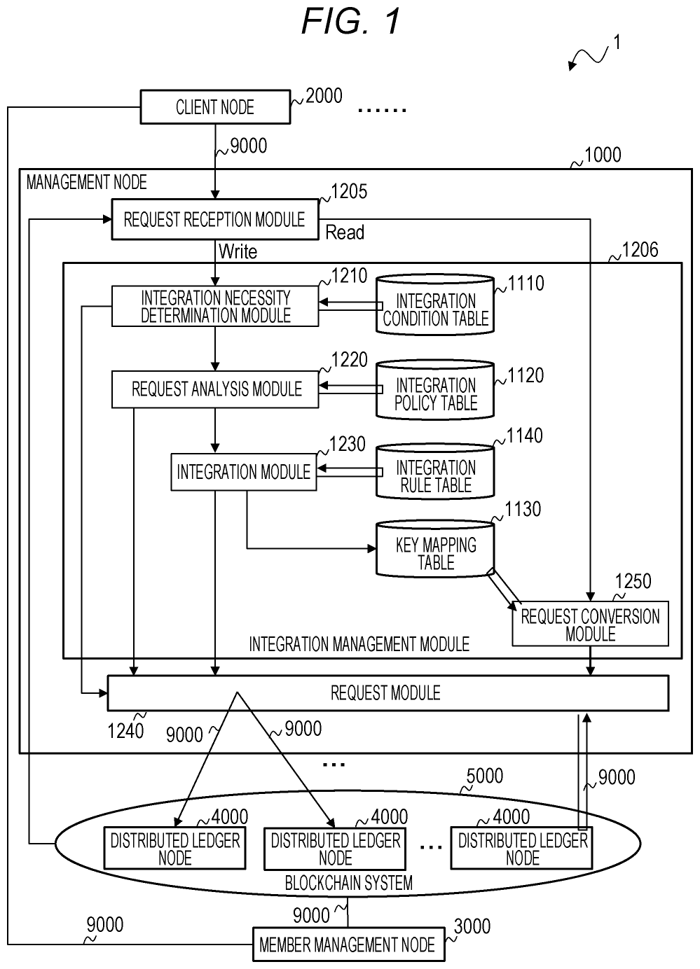

FIG. 1 is a diagram for explaining an example of the configuration of an information sharing assistance system 1 according to a first embodiment.

The information sharing assistance system 1 is a blockchain system used by an organization (industry group, management organization, consortium, etc.) composed of specific members (business person, business personnel, vendors, individuals, etc.) who perform a predetermined business. That is, the information sharing assistance system 1 is a so-called consortium type blockchain system.

Specifically, the information sharing assistance system 1 is configured to include a plurality of client nodes 2000, a management node 1000 which is communicatively connected to each client node 2000, and a blockchain system 5000 which is communicatively connected to each client node 2000 and management node 1000.

The client node 2000 is an information processing device used by each member for business, and is provided in, for example, a business office, a data center, or the like of each member. The client node 2000 creates data (business data) related to the member's business, and sends a predetermined processing request (hereinafter, referred to as TX, request, or transaction data) for the blockchain system 5000 related to the created business data to the management node 1000.

In this embodiment, TX is configured to include a key which is an identifier of the request and a value (that is, data including business data) which is the content of the request (KVS: Key-Value Store).

The blockchain system 5000 is configured to include a plurality of distributed ledger nodes 4000 and a member management node 3000, which are communicatively connected to each other. The blockchain system 5000 is provided, for example, in a predetermined business office, data center, or the like.

Of these, the distributed ledger node 4000 is an information processing device. Each distributed ledger node 4000 shares and stores the history of TX sent by the client node 2000 in the form of blockchain data. The distributed ledger node 4000 processes the business data in response to the TX request by specifying the key and the value in the TX. The blockchain data is data that records the history of TX by, for example, combining block data including TX, hash, and nonce in chronological order.

Next, the member management node 3000 is an information processing device. The member management node 3000 issues a predetermined authentication information (private key) to a person (new client node 2000) who participates in the blockchain system 5000 and intends to share business data with other members, and registers the person as a new member.

The management node 1000 is an information processing device managed by a predetermined management company or the like, and is provided in, for example, a business office or a data center of the management company.

The management node 1000 receives the TX transmitted from each client node 2000, integrates or converts these TXs according to a predetermined policy, and sends the integrated or converted processing request to the blockchain system 5000. Each distributed ledger node 4000 of the blockchain system 5000 creates or updates blockchain data based on the integrated or converted TX.

In this way, in the information sharing assistance system 1 according to this embodiment, the management node 1000 intervenes between the client node 2000 and the distributed ledger node 4000 to hook the processing related to TX (for example, integrating TX). Therefore, the throughput performance related to TX issued by the client node 2000 can be improved.

The information processing devices in the information sharing assistance system 1 are communicatively connected by a wired or wireless network 9000 such as a LAN (Local Area Network), a WAN (Wide Area Network), the Internet, or a dedicated line.

Next, the functions provided by each information processing device will be described.

### <Management Node Function>

First, the function of the management node 1000 will be described.

As illustrated in FIG. 1, the management node 1000 has functions which are realized by modules: a request reception module 1205; an integration management module 1206 including an integration necessity determination module 1210, a request analysis module 1220, an integration module 1230, and a request conversion module 1250; and a request module 1240.

In addition, the management node 1000 stores an integration condition table 1110, an integration policy table 1120, an integration rule table 1130, and a key mapping table 1140.

The request reception module 1205 receives a plurality of predetermined requests (that is, TX, request, or transaction data) regarding the business data for the blockchain system 5000 that shares the business data among the plurality of distributed ledger nodes 4000.

For example, the request reception module 1205 receives a plurality of TXs (hereinafter, referred to as WriteTX) for writing predetermined information to each distributed ledger node 4000 of the blockchain system 5000.

Further, for example, the request reception module 1205 receives a request for acquisition of target information (hereinafter, referred to as ReadTX) which is any business data among the business data indicated by the plurality of WriteTXs from the client node 2000.

The integration management module 1206 converts a plurality of TXs received by the request reception module 1205 (hereinafter, these TXs are also referred to as pre-integration TXs) into a processable format of each distributed ledger node 4000 of the blockchain system 5000 according to predetermined rules (the integration condition table 1110, the integration policy table 1120, and the integration rule table 1130), and integrates TX to create a new request (hereinafter, referred to as post-integration TX).

For example, the integration management module 1206 creates a post-integration TX for writing based on the plurality of TXs received by the request reception module 1205.

Specifically, first, the integration necessity determination module 1210 determines the necessity of TX integration based on the policy specified in the integration condition table 1110.

Then, for example, the integration necessity determination module 1210 determines whether the communication load in the blockchain system 5000 exceeds a predetermined threshold, and only when determining that the communication load exceeds the threshold, creates the integrated TX.

Here, the integration condition table 1110 will be described.

### (Integration Condition Table)

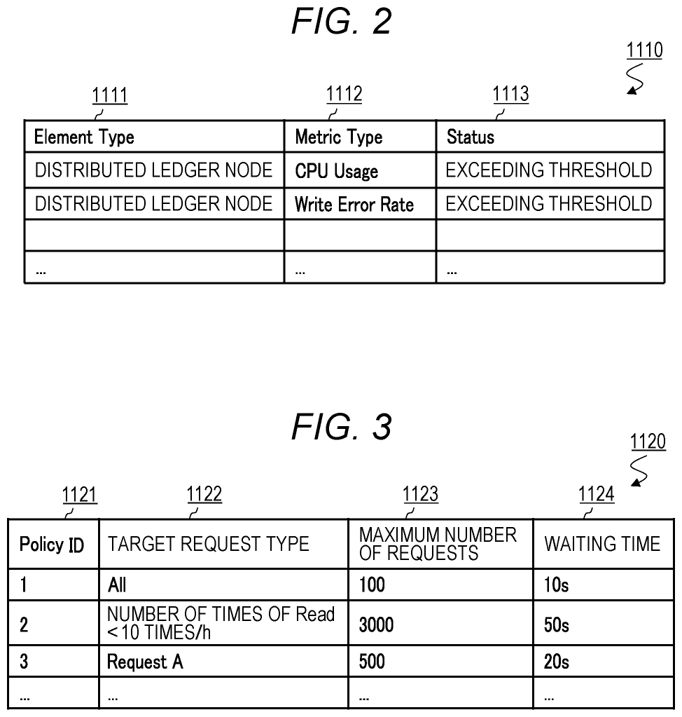

FIG. 2 is a diagram illustrating an example of the integration condition table 1110. The integration condition table 1110 stores information on the communication load (I/O path) as a requirement for starting TX integration.

The integration condition table 1110 is a database having one or more records configured by an element type 1111 which is the node type of the TX transmission destination (destination), a metric type 1112 which is the evaluation item of the node related to the element type 1111, and a status 1113 which is information indicating whether to integrate TX having the node related to the element type 1111 as the transmission destination depending on the state of the evaluation item related to the metric type 1112.

In the example illustrated in FIG. 2, when the CPU utilization rate of the distributed ledger node 4000 exceeds a threshold, the condition for determining that TX integration is necessary, and when the write error rate of the distributed ledger node 4000 exceeds a threshold, the conditions under which TX integration is deemed necessary are illustrated.

In addition to the information of the distributed ledger node 4000, the element type 1111 of the integration condition table 1110 may be set with the information of other nodes that perform processes to obtain predetermined effects (for example, the processing load on TX is reduced). For example, the member management node 3000 may be set with other nodes that perform a process on TX, such as a node (not illustrated) that performs a predetermined ordering service for guaranteeing the order of TXs. Further, there may be set a node that indirectly performs a process on TX, such as an IP switch (not illustrated) that transfers TX transmitted and received between nodes in the information sharing assistance system 1. Further, the status 1113 may store detailed contents of the state of the evaluation item, for example, an error code or an error content.

The contents of the integration condition table 1110 may be set by the user in advance or added later. Further, a predetermined information processing device may monitor the deterioration in performance of each node or the occurrence of a failure, and the result may be automatically reflected in each record of the integration condition table 1110. For example, the value of status 1113 may be manually set by the user, the value of the evaluation item for the metric type 1112 may be automatically set to the status 1113, or a value based on information from other records may be automatically set to the status 1113.

Further, the integration condition table 1110 may be set with an integrated condition of the contents of a plurality of records. For example, when a plurality of failure events occur at the same time, a new condition may be set by using a logical expression such as AND.

Next, as illustrated in FIG. 1, the request analysis module 1220 analyzes TX and selects a request to be integrated based on the policy specified in the integration policy table 1120.

For example, the request analysis module 1220 determines the types of a plurality of TXs received by the request reception module 1205, and creates a post-integration TX only when the types satisfy a predetermined condition.

In addition, in a case of creating the integrated TX, the request analysis module 1220 deletes unnecessary information for a processable format of each distributed ledger node 4000 of the blockchain system 5000 from among the plurality of TXs received by the request reception module 1205, and creates the integrated TX.

Further, in a case of integrating the plurality of TXs, the request analysis module 1220 starts creating the integrated TX when determining that a predetermined period of time (waiting time) has elapsed after a predetermined TX (for example, the first received TX) has received among the plurality of TXs received by the request reception module 1205.

Further, in a case of integrating the plurality of TXs, the request analysis module 1220 determines whether the number of the plurality of TXs received by the request reception module 1205 exceeds a predetermined value, and when determining that the number exceeds the predetermined value, starts creating the integrated TX.

Here, the integration policy table 1120 will be described.

### (Integration Policy Table)

FIG. 3 is a diagram illustrating an example of the integration policy table 1120. The integration policy table 1120 is information specifying a policy regarding a condition on which the integration of TX starts according to the type of TX when the integration of TX is determined based on the integration condition table 1110.

The integration policy table 1120 is configured by one or more records containing elements that include a policy ID 1121 which is the information for specifying a second policy, a target request type 1122 which is the information of the type of TX which is the target for starting the integration in the second policy related to the policy ID 1121, the maximum number of requests 1123 which is the maximum number of TXs which can be integrated in the policy related to the policy ID 1121, and a waiting time 1124 that is a waiting time for receiving TX related to the maximum number of requests 1123 in the policy related to the policy ID 1121.

Here, in the target request type 1122, the information of the classification that can distinguish TX is registered. For example, the name of the request may be registered directly (for example, “Request A”), or information indicating that all types of requests are to be integrated (for example, “ALL”) may be registered.

In the example illustrated in FIG. 3, for each of all types of TX (“All”) received by the management node 1000, when the management node 1000 receives the type of TX “100” times, or “10 seconds” have elapsed after TX of the type has been received at a predetermined time (for example, when the management node 1000 accumulates TX of the type for 10 seconds), the integration of TX of the received types starts (the policy ID 1121 is a policy of “1”).

In addition, regarding WriteTX that requires the blockchain system 5000 to write business data that is received by the management node 1000 and is read only “less than 10 times per hour”, when the management node 1000 has received TX of the type “3000 times”, or “50 seconds” has elapsed after TX of the type has been received at a predetermined time, the integration of received TX of the type starts (the policy ID 1121 is a policy of “2”).

That is, this policy registers TX as “Number of times of Read<10 times/h” so that the data is read only 10 times or less per hour after writing predetermined data by WriteTX. In this case, the management node 1000 specifies a read frequency by acquiring the history of TX received so far (for example, using the integration temporary storage table described later).

Next, regarding TX of the type “Request A” received by the management node 1000, when the management node 1000 receives TX of the type “500” times, or “20 seconds” have elapsed after TX of the type is received at a predetermined time, the integration of received TX of the type starts (the policy ID 1121 is a policy of “3”).

The contents of the above integration policy table 1120 may be set by the user in advance or added later. Moreover, the contents of the integration policy table 1120 are not limited to those illustrated here. For example, the contents of the integration rule table 1130 described later may be set in the integration policy table 1120.

Next, as illustrated in FIG. 1, the integration module 1230 integrates TX according to the rules specified in the integration rule table 1130 to create a post-integration TX.

For example, in a case of creating an integrated TX, the integration module 1230 deletes unnecessary information for a format that can be processed by the blockchain system 5000 from among the plurality of TXs received by the request reception module 1205 to create the integrated TX.

Here, the integration rule table 1130 will be described.

### (Integration Rule Table)

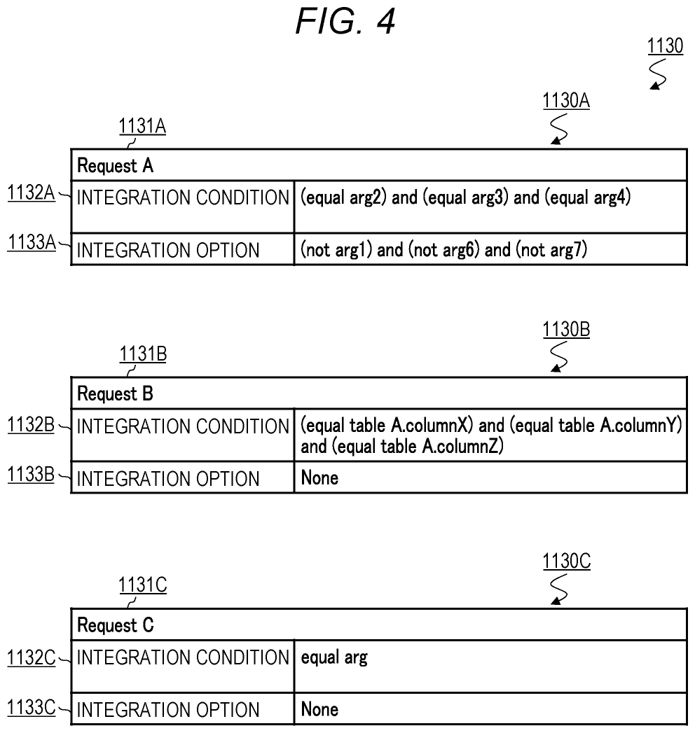

FIG. 4 is a diagram illustrating an example of the integration rule table 1130. The integration rule table 1130 is information on the integration rules of TX set for each type of TX.

One or more integration rule tables 1130 are provided for each type of TX (integration rule tables 1130A, 1130B, and 1130C).

The integration rule table 1130 is configured to include at least one or more records containing elements which include a request type 1131 (1131A, 1131B, 1131C), which is the type of TX to be integrated, an integration condition 1132 (1132A, 1132B, 1132C), which is the condition that the TX to be integrated must satisfy, and an integration option 1133 (1133A, 1133B, 1133C) which is an additional condition (option information) in a case of integrating TX based on the condition related to the integration condition 1132.

In the example of FIG. 4, the integration rule table 1130 includes the integration rule table 1131A for a request of type “Request A”, the integration rule table 1131B for a request of type “Request B”, and the integration rule table 1131C for a request of type “Request C”.

First, the integration rule table 1130A includes the integration condition 1131A defined by a logical expression using the argument attribute of TX, and the integration option 1133A corresponding thereto. Specifically, the integration condition 1131A is set to “(equal arg2) and (equal arg3) and (equal arg4)”, which specifies a condition that the value of a second argument in TX is equal, the value of a third argument is equal, and the value of a fourth argument is equal. In addition, “(not arg1) and (not arg6) and (not arg7)” is set in the integration condition 1131A, which specifies option information that a first argument is unnecessary for the request after integration and a sixth argument is unnecessary for the request after integration, and a seventh argument is unnecessary for the request after integration.

The integration rule table 1130B does not use the argument attribute of TX, but the integration condition 1131B defined by the logical expression using any other table (“Table A” in the drawing) held by the information sharing assistance system 1 and the integration option 1133B corresponding thereto. Specifically, the integration condition 1131B is set to “(in table A.column X) and (in table A.column Y) and (in table A.column Z)”, which specifies a condition that the values of columns X, Y, and Z for each entry of Table A are referred and TXs containing the same character string as the values of these columns X, Y, and Z are targeted for integration. In addition, the integration option 1133B is set to “None” and there is no option information.

In the integration condition 1132C of the integration rule table 1130C, the logical expression “equal arg” indicating “requests with the same argument attributes are all targeted for integration” is set. In addition, the information “None” indicating “option information does not exist” is set in the integration option 1133C. That is, the integration rule table 1130C is a table which is used when the content itself of the request indicated by each TX related to integration is the same, but other elements accompanying the TX (for example, the timing of request execution by the TX) are different. For example, the integration rule table 1130C is used when it is only necessary to know the number of times arbitrary information is written. For example, by applying the policy of the integration rule table 1130C, it is possible to integrate TX while setting the number of TXs to be integrated to the post-integration TX (without processing TX with different argument attributes).

The items and contents of the integration rule table 1130 are not limited to those illustrated here. For example, as the information reference destination table in each integration rule table 1130 as described above, an arbitrary table in the information sharing assistance system 1 may be designated. For example, a business information management table 2110 of the client node 2000, a shared information table 4120 of the distributed ledger node 4000, and the like may be set for the integration condition 1132.

In addition, the items and contents of the integration condition 1132 and the integration option 1133 in the integration rule table 1130 may be set in advance by the user, or added, modified, deleted, etc. afterwards. Further, the number of integration rule tables 1130 is arbitrary, and new integration rule tables 1130 may be added or deleted, or the plurality of integration rule tables 1130 may be integrated.

Next, as illustrated in FIG. 1, the request module 1240 sends the post-integration TX to the distributed ledger node 4000.

That is, the request module 1240 causes each distributed ledger node 4000 of the blockchain system 5000 to process the request related to the pre-integration TX by transmitting the post-integration TX to the blockchain system 5000.

For example, the request module 1240 transmits the post-integration TX created by the integration management module 1206 to the blockchain system 5000, so that each distributed ledger node 4000 of the blockchain system 5000 stores the plurality of pieces of information related to the plurality of pre-integration TXs.

In addition, the request module 1240 receives reply data to the integrated TX from the blockchain system 5000.

The request conversion module 1250 creates and stores the key mapping table 1140 that specifies the correspondence between the pre-integration TX and the post-integration TX. By using this key mapping table 1140, the management node 1000 can ensure the consistency of TX transmitted and received between the client node 2000 and the blockchain system 5000.

Further, the request conversion module 1250 acquires any TX (business data) among the post-integration TXs written in advance from the plurality of TXs (business data) stored in the blockchain system 5000 based on a predetermined acquisition request (new ReadTX corresponding to the post-integration TX) corresponding to ReadTX received by the request reception module 1205, which is specified based on the key mapping table 1140, and transmits the acquired TX (business data) to the client node 2000.

Here, the key mapping table 1140 will be described.

### (Key Mapping Table)

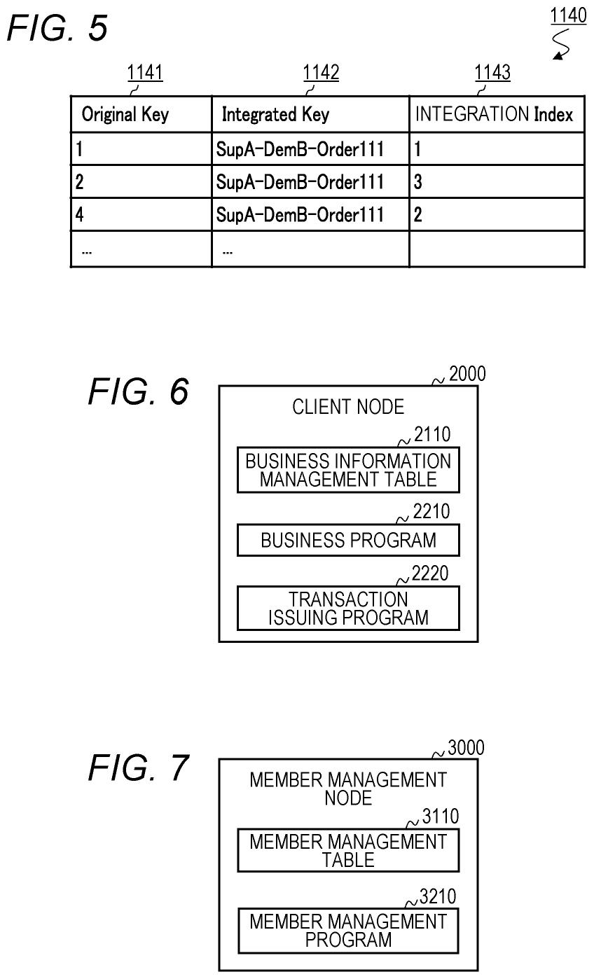

FIG. 5 is a diagram illustrating an example of the key mapping table 1140. The key mapping table 1140 is stored with information indicating the correspondence between an identifier or key (hereinafter, referred to as pre-integration identifier or pre-integration key) of TX transmitted by the client node 2000 and an identifier or key (hereinafter, referred to as post-integration identifier or post-integration key) of TX newly transmitted by the management node 1000 in correspondence with the TX.

The key mapping table 1140 is a database configured by one or more records containing items which include an original key 1141 in which the pre-integration identifier is set, an integrated key 1142 in which the post-integration identifier associated with the pre-integration identifier related to the original key 1141 is set, and an integration index 1143 which is a sub-identifier or sub-key (hereinafter, referred to as post-integration sub-identifier or post-integration sub-key) in the post-integration identifier related to the integrated key 1142 corresponding to the pre-integration identifier related to the original key 1141.

In the example of FIG. 5, since the sub-identifier corresponding to the pre-integration identifier “1” is “1”, the TX related to this pre-integration identifier is integrated as the first element in TX related to the post-integration identifier “SupA-DemB-Order111”. Similarly, since the sub-identifier corresponding to the pre-integration identifier “2” is “3”, the TX related to this pre-integration identifier is integrated as the third element in TX related to the post-integration identifier “SupA-DemB-Order111”.

The key mapping table 1140 may have a configuration different from that described here as long as it specifies the correspondence between the pre-integration TX and the post-integration TX.

### <Client Node Function>

Next, FIG. 6 is a diagram for explaining an example of the functions provided in the client node 2000. The client node 2000 has each function realized by a business program 2210 and a transaction issuing program 2220, respectively. In addition, the client node 2000 stores the business information management table 2110.

The business program 2210 accepts input of business-related information from members and creates business data based on the input information. The business program 2210 stores this business data in the business information management table 2110. In addition, the business program 2210 creates TX related to the input business data.

In this embodiment, at least WriteTX, which is a request for writing business data to each distributed ledger node 4000 of the blockchain system 5000 in the form of blockchain data, and ReadTX which is a request for reading target business data in the blockchain data stored by each distributed ledger node 4000 of the blockchain system 5000 are included in TX.

The business program 2210 is assumed to add predetermined issuer information to the created TX. It is assumed that this issuer information is accompanied by the authentication information of each member (here, the private key is used, but the information is not limited to other types of information) created in advance by the member management node 3000.

The transaction issuing program 2220 sends the TX created by the business program 2210 to the management node 1000.

### <Function of Member Management Node>

Next, FIG. 7 is a diagram for explaining an example of the functions provided by the member management node 3000. The member management node 3000 has a function realized by a member management program 3210. In addition, the member management node 3000 stores a member management table 3110.

The member management program 3210 creates the authentication information (private key) of each member participating in the blockchain system 5000 (consortium).

In addition, when the distributed ledger node 4000 receives TX from the client node 2000, the member management program 3210 performs an authentication process of the client node 2000 which has transmitted TX, a signature assignment process for this TX, and an execution authority to the member of the smart contract related to this TX, based on the authentication information (private key) accompanied to this TX and the information (here, assumed as a public key) corresponding to the authentication information.

In this way, the member management program 3210 determines whether TX is transmitted by a member having a legitimate authority (the client node 2000). As a result, only members with legitimate authority can perform business work related to TX.

Next, the member management table 3110 stores information such as the authentication information (private key) of each member and the corresponding public key.

### <Distributed Ledger Node>

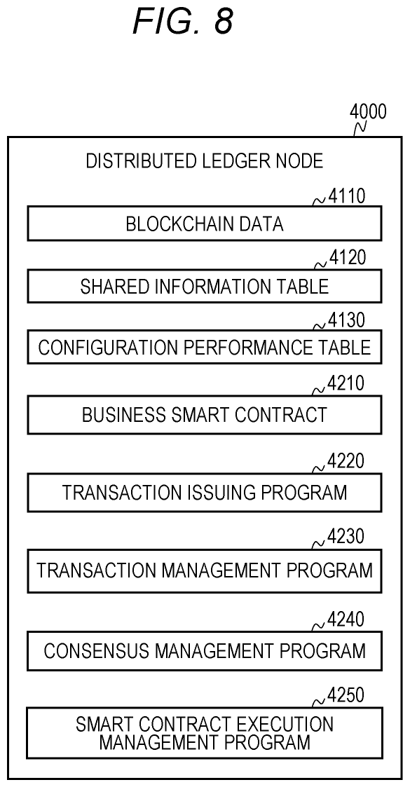

Next, FIG. 8 is a diagram for explaining an example of the functions provided by the distributed ledger node 4000. The distributed ledger node 4000 has a function realized by each program of a transaction issuing program 4220, a transaction management program 4230, a consensus management program 4240, and a smart contract execution management program (hereinafter, also referred to as SC execution management program 4250). In addition, the distributed ledger node 4000 stores each information of a business smart contract 4210, a blockchain data 4110, a shared information table 4120, and a configuration performance table 4130.

The transaction issuing program 4220 issues TX (distributed ledger node 4000 can issue TX by itself).

The transaction management program 4230 receives the TX transmitted over the network 9000. Further, the transaction management program 4230 acquires predetermined data from the blockchain data 4110 in response to a request indicated by TX from the client node 2000 via the management node 1000, and displays the contents of the acquired data in a predetermined screen of the client node 2000.

As described above, when the transaction management program 4230 receives TX, the member management node 3000 executes the member management program 3210, and checks whether the transmitting subject (the client node 2000) of this TX has a legitimate authority.

A consensus management program 4240 performs a consensus building process with another distributed ledger node 4000 as to whether to accept and process the TX received by the transaction management program 4230.

The SC execution management unit 4250 executes each smart contract including the business smart contract 4210, which will be described later, which has been deployed in advance. The SC execution management unit 4250 stores the information (for example, business data related to TX) obtained by executing each smart contract in the blockchain data 4110.

In addition, the SC execution management unit 4250 stores information (state information) indicating the current state of TX in the shared information table 4120. The SC execution management unit 4250 also deploys each smart contract.

Next, the business smart contract 4210 is a processing program (smart contract) for executing each business. The business smart contract 4210 implements the business logic for each business system related to the business of each member.

The blockchain data 4110 and the shared information table 4120 are information on the business smart contract 4210 related to various businesses.

The blockchain data 4110 is TX history information received by the transaction management program 4230. The blockchain data 4110 is shared among the distributed ledger nodes 4000.

The shared information table 4120 stores the integration condition table 1110, the integration policy table 1120, and the integration rule table 1130. These tables are shared between each distributed ledger node 4000.

The configuration performance table 4130 stores the configuration information of the information processing device such as the distributed ledger node 4000. In this embodiment, this configuration information is assumed to be information on the hardware specifications or hardware performance of each information processing device. That is, the configuration information is, for example, the specifications of the CPU or memory of the information processing device, the information of the smart contract executed by the information processing device, the CPU utilization rate or the write error rate of the information processing device, and the like.

### <Hardware>

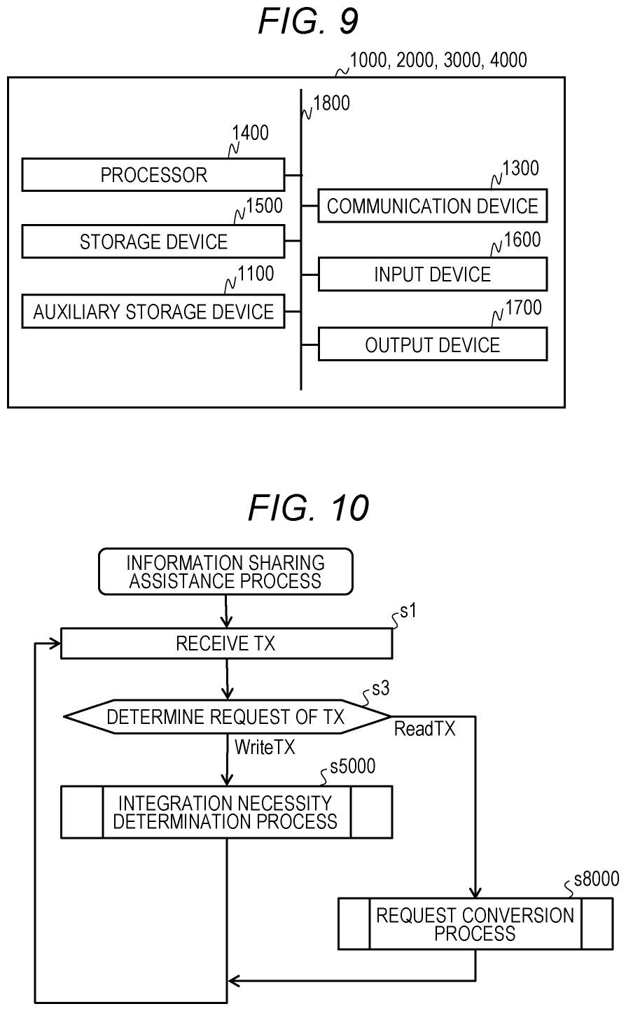

Here, FIG. 9 is a diagram for explaining an example of hardware included in each information processing device (the management node 1000, the client node 2000, the member management node 3000, and the distributed ledger node 4000) in the information sharing assistance system 1. These information processing devices include a processor 1400 such as a CPU, a storage device 1500 such as a RAM (Random Access Memory) and a ROM (Read Only Memory), an auxiliary storage device 1100 such as an HDD (Hard Disk Drive), an SSD (Solid State Drive), and a flash memory, an input device 1600 such as a keyboard or a touch panel, an output device 1700 such as a monitor or a display, and a communication device 1300 such as a network interface card for communication with other information processing devices, and these devices are connected by an internal communication line 1800.

Each function of each information processing device in the information sharing assistance system 1 described above can be performed by using dedicated hardware or by reading a program (module) stored in the storage device 1500 or the auxiliary storage device 1100 by the processor 1400, and using an input device 1600, an output device 1700, a communication device 1300, and the like. Further, each program (module) may be recorded in advance in a recording medium that can be read by each information processing device, or may be introduced when necessary via a storage medium or a predetermined communication network. In addition, each program may be executed in a virtual environment such as a hypervisor type or a container type.

### <Processes>

Next, the processes performed in the information sharing assistance system 1 will be described. In the information sharing assistance system 1, the management node 1000 executes a predetermined process for TX from the client node 2000, and the blockchain system 5000 executes a process for sharing information about this TX (hereinafter, referred to as an information sharing assistance process).

### <Information Sharing Assistance Process>

FIG. 10 is a flowchart for explaining an outline of the information sharing assistance process. The information sharing assistance process is executed, for example, after the management node 1000 and the blockchain system 5000 are started.

First, the management node 1000 waits for receiving TX from the client node 2000 (s1).

Specifically, for example, the business program 2210 of the client node 2000 creates TX related to a predetermined business, and the transaction issuing program 2220 transmits the TX. The request reception module 1205 of the management node 1000 waits for the reception of this transmitted TX.

When the request reception module 1205 receives TX from the client node 2000, it determines the request of the received TX (s3).

If the received TX is WriteTX (s3: WriteTX), the integration necessity determination module 1210 starts the execution of an integration necessity determination process s5000 which includes determining whether a plurality of WriteTXs including the received WriteTX is integrated into one TX (post-integration TX) (s5). After that, the process of s1 is repeated.

On the other hand, when the received TX is ReadTX (s3: ReadTX), the request conversion module 1250 executes a request conversion process s8000 which includes converting the received ReadTX into the data corresponding to the post-integration TX. After that, the process of s1 is repeated.

The details of the integration necessity determination process s5000 and the request conversion process s8000 will be described below.

### <Integration Necessity Determination Process>

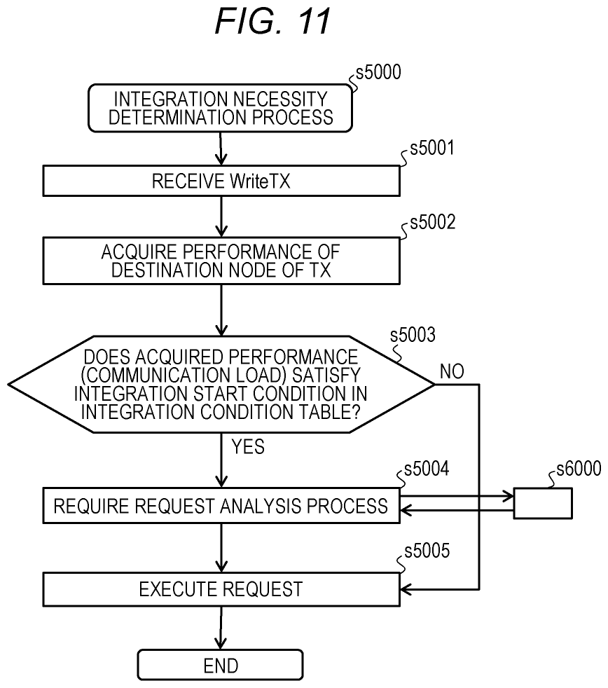

FIG. 11 is a flowchart for explaining an example of the integration necessity determination process s5000. When the integration necessity determination module 1210 receives WriteTX (s5001), it acquires the performance information of the destination node (component) indicated by the received WriteTX (s5002).

Specifically, for example, the integration necessity determination module 1210 refers to the configuration performance table 4130 acquired in advance and cached or acquired in this step to provide information on the performance of the destination indicated by the received WriteTX.

As another method of acquiring the configuration performance table 4130, for example, a transaction issuing program 4220 of each distributed ledger node 4000 agrees with the distributed ledger node 4000 to send the information of the configuration performance table 4130 to the management node 1000. After that, each distributed ledger node 4000 may periodically transmit the configuration performance table 4130 to the management node 1000, and the management node 1000 may acquire this configuration performance table 4130. As described above, the method and timing of acquiring the configuration performance table 4130 are not particularly limited.

The integration necessity determination module 1210 compares the performance information acquired in s5002 with the integration condition table 1110 to determine whether the communication load of the blockchain system 5000 is high, that is, whether the received WriteTX is integrated with another WriteTX (s5003).

Specifically, for example, the integration necessity determination module 1210 acquires all the contents of the records in which the destination (node) indicated by the received WriteTX is set in the element type 1111 in the integration condition table 1110, and determines whether the destination (node) indicated by the received WriteTX meets the performance conditions specified by the metric type 1112 and the status 1113 of the acquired record.

For example, if the destination is the distributed ledger node 4000, in the example of FIG. 2, it is determined whether each distributed ledger node 4000 satisfies the condition that “CPU Usage” (the metric type 1112) is “exceeding threshold” (the status 1113) (for example, whether the CPU usage of the distributed ledger node 4000 exceeds 99%).

When determining that the received WriteTX is integrated with another WriteTX (s5003: Yes), the integration necessity determination module 1210 executes the process of s5004 described below. On the other hand, when determining that the received WriteTX is not integrated with another WriteTX (s5003: No), the integration necessity determination module 1210 executes the process of s5005 described later in order to perform the process indicated by WriteTX.

In s5004, the integration necessity determination module 1210 sends a request analysis process request, which is a request for analyzing WriteTX to create a post-integration TX, to the request analysis module 1220 (s5004). After that, the process of s5005 is performed to execute the process indicated by the post-integration TX.

In s5005, the integration necessity determination module 1210 sends an execution request (that is, the integrated TX) of the process (the process of WriteTX (in the case of s5003: No), or the process of the integrated TX (in the case of s5003: Yes) related to WriteTX to the request module 1240 (s5005). The request module 1240 sends the post-integration TX to each distributed ledger node 4000.

After that, each distributed ledger node 4000 adds the received integrated TX to the blockchain data 4110. In addition, each distributed ledger node 4000 performs a predetermined consensus building process regarding the blockchain data 4110. This completes the integration necessity determination process (s5006).

In the above integration necessity determination process, the integration necessity determination module 1210 has acquired the performance information (the configuration performance table 4130) in order to determine the necessity of TX integration, but other information may be acquired. For example, the integration necessity determination module 1210 may acquire information (for example, information on the determination result of performance threshold, information on errors of performance deterioration) on the performance created by each node at each timing instead of acquiring the performance information.

In addition, since it is assumed that TX is always integrated even if performance deterioration does not occur, the integration necessity determination module 1210 may always execute the process after s5004 without executing the process of s5003.

Further, the client node 2000 may be able to switch between accessing the distributed ledger node 4000 via the management node 1000 and directly accessing the distributed ledger node 4000. Specifically, for example, the client node 2000 transmits access destination information associated with TX (for example, information on the address and service name of the distributed ledger node 4000, or information on the address and service name of the management node 1000), and the subject (the management node 1000 or distributed ledger node 4000) corresponding to this information processes the TX.

### <Request Analysis Process>

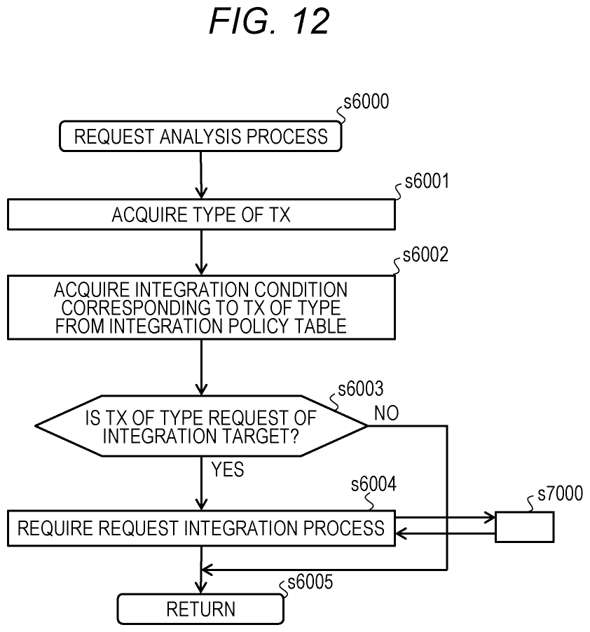

FIG. 12 is a flowchart for explaining an example of the request analysis process. First, when the request analysis module 1220 receives the request analysis process request (s5004) from the integration necessity determination module 1210, the request analysis module 1220 specifies the type of TX received in s5001 (s6001).

The request analysis module 1220 also acquires the integration policy table 1120 (s6002).

The request analysis module 1220 determines whether the type of WriteTX specified in s6001 is the TX to be integrated based on the integration policy table 1120 acquired in s6002, and specifies the policy to be applied at the time of integration (s6003).

Specifically, for example, the request analysis module 1220 refers to each record in the integration policy table 1120, and acquires all the records in which the WriteTX type information specified in s6001 is set in the target request type 1122, and selects one of the acquired records.

For example, in FIG. 8, when the type of WriteTX is “Request A”, two records, that is, a record whose policy ID 1121 in which “All” (TX of all types) is set the target request type 1122 is “1”, and a record whose policy ID 1121 in which “Request A” is set in the target request type 1122 is “3”, are specified. And only one of these two records is selected. In this way, when there are a plurality of policies for TX of the type to be determined, the requests are aggregated according to one of the policies. In this case, the policy may be selected by, for example, a predetermined criterion (for example, the one having a larger value related to the maximum number of requests 1123 is selected), or the user may be allowed to select the policy.

In this way, if the policy to be applied at the time of integration can be specified (s6003: Yes), the request analysis module 1220 transmits a request integration request for requesting the integration of TX including information of the type (hereinafter, referred to as integration type) of TX to be integrated to the request integration module 1230 (s6004), ends the request analysis process, and returns to the integration necessity determination process (s6005). On the other hand, if the policy to be applied at the time of integration cannot be specified (s6003: No), the request analysis module 1220 ends the request analysis process and returns to the integration necessity determination process (s6005).

### <Request Integration Process>

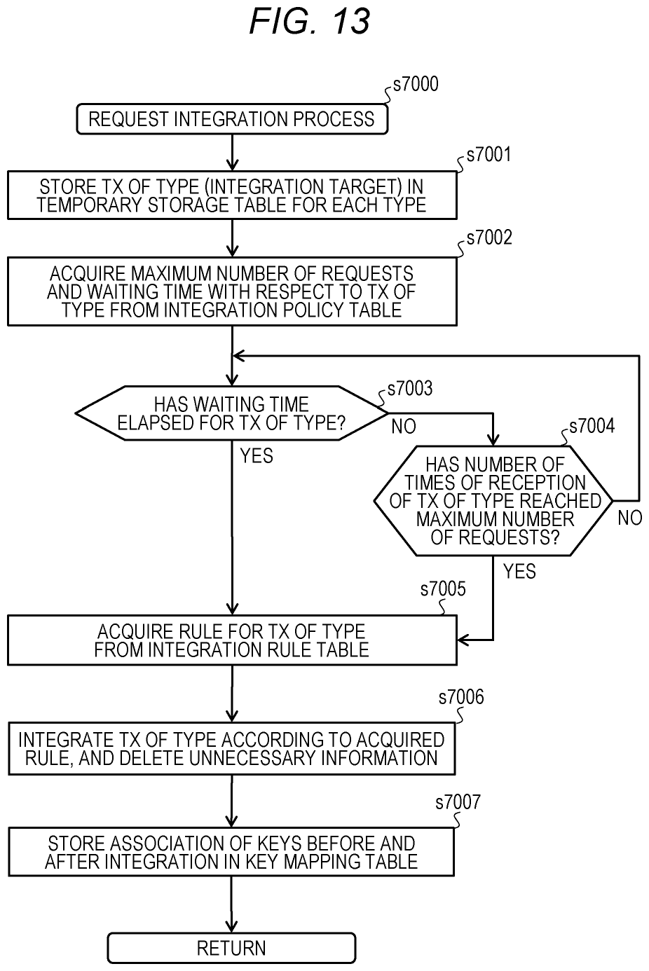

FIG. 13 is a flowchart for explaining an example of a request integration process. When receiving a request integration process request from the request analysis module 1220, and TX of the integration type is received, the integration module 1230 starts a process of storing the TX in a predetermined integration temporary storage table (not illustrated) (s7001). After that, this process is continued until TX of the integration type is integrated (s7006).

The integration temporary storage table is, for example, information that stores records in which each received TX, the reception time of each TX, and the number of received TXs (number of receptions) are associated with each TX type. The integration temporary storage table may be information for each other unit, not for each type of TX. For example, it may be information for each type of TX illustrated in the integration rule table 1130.

Further, the integration temporary storage table may be configured to create a backup at a predetermined timing (for example, before the integration of TX (described later) is executed) at a location (for example, another information processing device, a predetermined storage device, cloud, etc.) other than the management node 1000. As a result, it is possible to prepare for the case where the information of the integration temporary storage table cannot be referred to due to some failure.

In addition, the integration module 1230 acquires information of the integration condition related to TX of the integration type from the integration policy table 1120 (s7002).

Specifically, for example, the integration module 1230 refers to the integration policy table 1120 and acquires the contents of the maximum number of requests 1123 and the waiting time 1124 of the record in which the information of TX of the integration type is set in the target request type 1122.

The integration module 1230 compares the contents of the integration temporary storage table with the information of the integration condition acquired in s7002 to determine whether the integration of TX of the integration type starts (s7003 to S7004).

First, the integration module 1230 determines whether the waiting time required to integrate TX of the integration type has elapsed since a predetermined calculation time (s7003).

Specifically, for example, the integration module 1230 acquires all the contents of the records related to TX of the integration type in the integration temporary storage table so as to determine whether the time length from the time when TX of the integration type is first received (or time stored in the integration temporary storage table) to the current time exceeds the waiting time which is the integration condition acquired in s7002. The integration module 1230 may acquire the current time information by any method, but it is preferable to acquire the information by the same method as the method of acquiring the time when TX of the integration type is first received.

If the required waiting time has elapsed (s7003: Yes), the integration module 1230 executes the process of s7005 described later, and if the required waiting time has not elapsed (s7003: No), the integration module 1230 executes the process of s7004 described below.

In s7004, the integration module 1230 determines whether TX of the integration type has been received a predetermined number of times (maximum number of requests) or more from a predetermined calculation time.

Specifically, for example, the integration module 1230 acquires all the contents of the records related to TX of the integration type in the integration temporary storage table so as to determine whether the number of times of receiving TX of the integration type after the time when TX of the integration type is first received (or time when being stored in the integration temporary storage table) exceeds the maximum number of requests which is the integration condition acquired in s7002.

If TX of the integration type has been received more than a predetermined number of times (s7004: Yes), the integration module 1230 executes the process of s7005 described below, and if TX of the integration type has not been received more than the predetermined number of times (s7004: No), the integration module 1230 repeats the process after s7003.

In s7005, the integration module 1230 first acquires information on the integration method of TX of the integration type from the integration rule table 1130 in order to start the integration of TX of the integration type.

Specifically, for example, the integration module 1230 specifies the integration rule table 1130 related to TX of the integration type among a plurality of integration rule tables 1130, and the contents of the integration condition 1132 and the integration option 1133 of the specified integration rule table 1130 are acquired.

The integration module 1230 integrates TX of the integration type and creates a new TX (that is, the post-integration TX) based on the information acquired in s7005 (s7006).

Specifically, for example, the integration module 1230 reconstructs all the values (business data, etc.) in TX of the integration type recorded in the integration temporary storage table according to the condition indicated by the integration condition 1132 of the integration rule table 1130 acquired in s7005 into one value, and applies the rule indicated by the integration option 1133 acquired in s7005 to the reconstructed value so as to create the post-integration TX (TX of which the value portion is changed compared to the pre-integration TX). At this time, the integration module 1230 sets a predetermined key (post-integration key) in the post-integration TX to the post-integration TX.

The integration module 1230 creates or updates the key mapping table 1140 to associate TX to be integrated in s7006 (pre-integration TX) with the post-integration TX created in s7006 (s7007). The key mapping table 1140 is used for the request conversion process related to ReadTX, which will be described later. After that, the process returns to the request analysis process.

Specifically, for example, the integration module 1230 sets the identifier (key) of each TX of the integration type recorded in the integration temporary storage table to the original key 1141, sets the identifier (key) of the integrated TX created in s7006 to the integrated key 1142, and creates one or a plurality of new records, in which the integrated sub-key corresponding to each TX of the integration type stored in the integration temporary storage table to the integration index 1143, in the key mapping table 1140.

The integration module 1230 deletes (discards) the record related to TX that has been integrated by the process up to s7006 in the integration temporary storage table. Therefore, it is possible to avoid wasting storage space.

### (Specific Example of Integration Process)

Here, a specific example of the process of s7006 and s7007 will be described. First, it is assumed that the WriteTX sent by a transaction issuing unit 2220 of the client node 2000 is the following three requests: Request A (1, Company A, Company B, Trade111, ID_03a23X81z19nd, 1, 2); Request A (2, Company A, Company B, Trade111, ID_AdsfKj034hafk, 2, 2); Request A (3, Company A, Company B, Trade112, ID_93jdlfhdijer1, 1, 2).

In this case, in s7005, the integration module 1230 acquires a request (TX), which has the same second argument, third argument, and fourth argument based on the integration condition 1132A related to “Request A” in the integration rule table 1130A, from the information of the pre-integration TX in the integration temporary storage table. Then, the integration module 1230 deletes unnecessary arguments from the request (TX) based on the integration option 1133A of the integration rule table 1130A. As a result, “Request A′ (CompanyA-CompanyB-Trade111, (ID_03a23X81z19nd, ID_AdsfKj034hafk))” is created as the post-integration TX.

After this, the integration module 1230 adds the information of correspondence between the first argument (assuming the information equivalent to the Key in KVS (Key-Value Store)) of the pre-integration TX and the information of the first argument of the post-integration TX to the key mapping table 1140. At this time, the integration module 1230 associates the post-integration TX with the pre-integration TX of which the first argument is “1” in the order of values in the second argument of the post-integration TX and stores “1” in the integration index 1143 of the key mapping table 1140 as a post-integration TX sub-key of the post-integration TX, and associates the post-integration TX to the pre-integration TX of which the first argument is “2” and stores “2” in the integration index 1143 of the key mapping table 1140 as a post-integration TX sub-key of the post-integration TX.

In the above request integration process, the integration module 1230 considers the waiting time (s7003) from a predetermined start time and the maximum number of requests (s7004) from a predetermined start time as the timing to start the TX integration, but the starting of TX integration may be determined by other methods.

For example, integration module 1230 may determine to start TX integration based only on either the maximum number of requests or the waiting time. In addition, the integration module 1230 may set other integration timings. For example, the integration module 1230 may determine when to start TX integration based on a predetermined timeout value set in association with each client node 2000.

Further, the integration module 1230 may execute the process after s7004 when the number of TXs stored in the integration temporary storage table reaches an arbitrary fixed value set in advance.

The integration module 1230 may also determine to start TX integration based on other integration requirements. For example, the integration module 1230 may determine a unit for integrating TX based on the parameter value indicating the business content stored in the business information management table 2110 of the client node 2000. For example, when dealing with TX related to the purchase of each part in order to purchase 100 parts for one predetermined product, the integration module 1230 determines whether all the 100 TXs related to each part are stored in the integration temporary storage table with reference to the business information management table 2110 where the correspondence between product ID and each part ID is stored. When TXs related to the 100 parts are stored in the integration temporary storage table, the integration of these TXs may be performed.

### <Request Conversion Process>

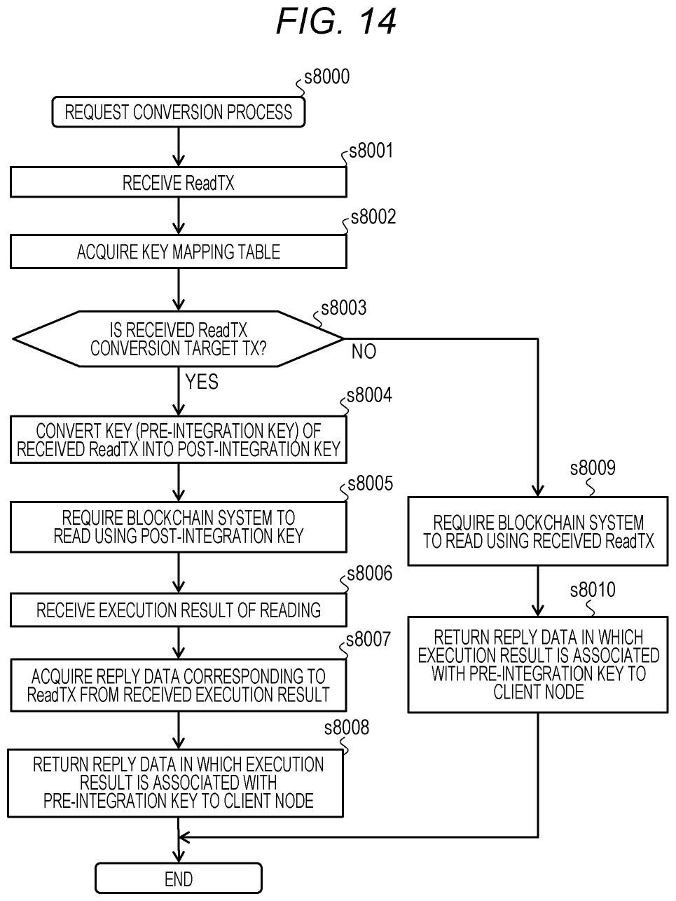

FIG. 14 is a flowchart for explaining an example of the request conversion process. First, when the request reception module 1205 of the management node 1000 receives ReadTX (s8001), the request conversion module 1250 acquires the key mapping table 1140 (s8002).

The request conversion module 1250 determines whether the ReadTX received in s8001 is a TX integrated by the request integration process (integrated TX) (s8003).

If ReadTX is the post-integration TX integrated by the request integration process (s8003: Yes), the following process of s8004 is executed, and if ReadTX is not the post-integration TX integrated by the request integration process (s8003: No), the process of s8009 described later is executed.

In s8004, the request conversion module 1250 converts the ReadTX key (pre-integration key) received in s8001 into the corresponding post-integration key based on the key mapping table 1140 acquired in s8002.

Specifically, for example, the request conversion module 1250 specifies the record in which the pre-integration key related to ReadTX is set to the original key 1141 from the key mapping table 1140, and acquires the integrated key 1142 of the specified record.

The request conversion module 1250 creates a new ReadTX (read request of business data) that stores the post-integration key acquired in s8004 in association with the business data to be read indicated by ReadTX received in s8001, and transmits the new ReadTX to the request module 1240 (s8005). Based on the received ReadTX, the request module 1240 receives response data including business data to be read, which is response data, from the distributed ledger node 4000 of the blockchain system 5000.

After that, the request conversion module 1250 receives the response data from the request module 1240 (s8006).

The request conversion module 1250 extracts the TX (business data) to be read indicated by the ReadTX received in s8001 from the received response data (s8007). This is because the response data received in s8006 contains business data related to a plurality of keys indicated by the integrated key 1142 (post-integration key) in the key mapping table 1140, so it is necessary to acquire only business data indicated by the original key 1141 (pre-integration key) corresponding to the integrated key 1142 from these pieces of business data.

The request conversion module 1250 creates data (reply data for ReadTX sent by the client node 2000) that associates the business data acquired in s8007 with the key related to ReadTX (pre-integration key) received in s8001, and transmits the created reply data to the client node 2000 that has transmitted ReadTX (s8008). This completes the request conversion process.

On the other hand, in s8009 and s8010, the request conversion module 1250 transmits the reply data to the client node 2000 without any special processing.

That is, the request conversion module 1250 transmits the ReadTX received in s8001 to the request module 1240 (s8009). The request module 1240 receives the response data from the distributed ledger node 4000 of the blockchain system 5000 based on the received ReadTX. The request conversion module 1250 receives the response data from the request module 1240.

The request conversion module 1250 transmits the reply data in which the received response data is associated with the key related to ReadTX (pre-integration key) received in s8001 to the client node 2000 that has transmitted ReadTX (s8010). This completes the request conversion process.

According to the request conversion process as described above, the client node 2000 can read the business data related to TX integrated and written in advance with only the normal ReadTX without any additional implementation.

In the request conversion process of this embodiment, the request process of s8005 and the execution result reception process of s8006 are executed synchronously, but these processes may be asynchronous. For example, after executing s8005, the execution of s8006 may be started asynchronously.

As described above, in the information sharing assistance method of this embodiment, the management node 1000 receives a plurality of TXs (WriteTX, etc.) transmitted to the blockchain system 5000, and integrates the plurality of received TXs according to a predetermined rule (the integration condition table 1110, the integration policy table 1120, and the integration rule table 1130) while keeping the format which can be handled by the blockchain system 5000 so as to create a new TX, and transmits this TX to the blockchain system 5000.

As a result, the number of requests related to the transaction for the blockchain system 5000 itself can be reduced. As a result, it is possible to improve the throughput performance of communication related to information sharing in the blockchain system 5000 (improvement of performance including the consensus building process and the writing process).

Further, according to the management node 1000, for example, the management node 1000 can integrate a plurality of requests based on rules or policies such as the load status in the information sharing assistance system 1, and write data related to the requests to the blockchain. Therefore, it is possible to improve the performance of the blockchain system 5000.

Specifically, in the blockchain system, as described in “Hyperledger Fabric” and the like, various processes such as consensus building related to TX, control of the request order of TX, and writing of data related to TX are required when processing each TX. Further, in each process, TX is transmitted and received between many management computers such as a client node 2000, an Ordering node (not illustrated in this embodiment), and a plurality of distributed ledger nodes 4000.

Therefore, according to the information sharing assistance method of this embodiment capable of reducing the number of requests related to TX, the blockchain system can exhibit particularly high performance as compared with the conventional one.

In particular, in the consortium type blockchain system illustrated in this embodiment, the effect of improving the performance by reducing the number of requests is very large compared to the disadvantage of increasing the size of the TX by reducing the number of requests. As a result, even when using a blockchain system that handles a large amount of stream data, it is possible to efficiently store the data in the blockchain data, and for business systems that have been difficult to handle blockchain data so far. However, it is possible to apply the blockchain system.

In recent years, the amount of data handled in society, such as IoT data and mobile data associated with product activities, and life data associated with human activities, has been increasing. Along with this, it is expected that the demand for securely storing a large amount of stream data while sharing it among a plurality of organizations will increase. Under such circumstances, the information sharing assistance method of this embodiment, which can efficiently store a large amount of stream data in blockchain data, can satisfy such a request.

### Second Embodiment

In the first embodiment, it is assumed that there is one management node 1000, but there may be a plurality of management nodes 1000. In such a case, for example, there may be a plurality of management organizations (industry groups).

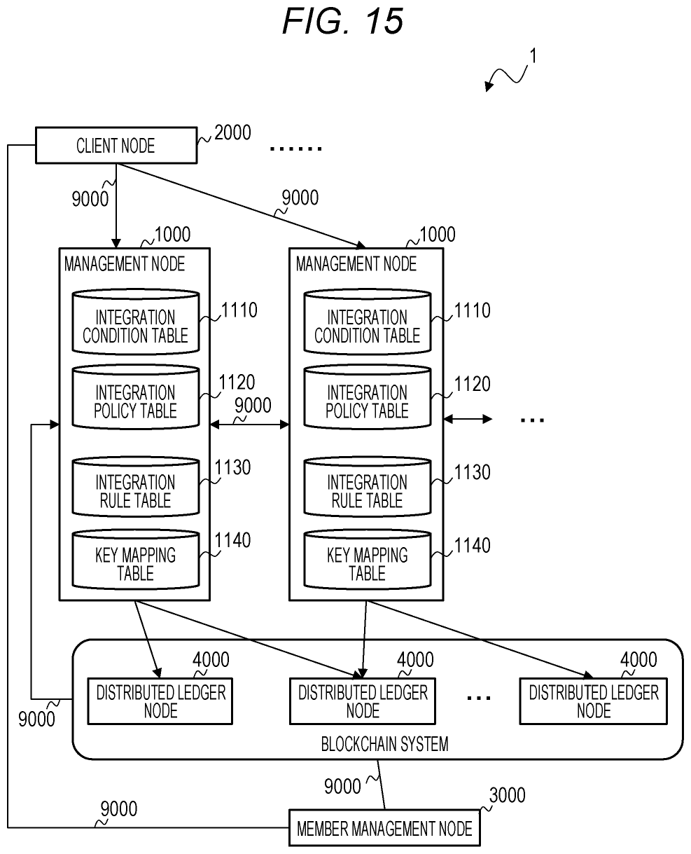

FIG. 15 is a diagram illustrating an example of the configuration of the information sharing assistance system 1 according to the second embodiment. The information sharing assistance system 1 of this embodiment is configured to include the plurality of management nodes 1000 that are communicatively connected to each other by the network 9000. The configurations and functions of the other nodes are the same as those in the first embodiment (note that the description is omitted because they are the same as those in the first embodiment).

In this case, each of the plurality of management nodes 1000 shares the information on the rules related to TX integration (integration condition table 1110, integration policy table 1120, or integration rule table 1130) and stores them in the form of blockchain data. This allows TX to be shared among the plurality of management organizations based on a unified policy. In addition, transaction processing can be performed consistently among the management organizations.

Further, instead of the management node 1000, each distributed ledger node 4000 may share information on rules related to TX integration and store it in the form of blockchain data. In this case, if there is a change such as creation, update, or deletion of the information of each rule, each distributed ledger node 4000 builds a consensus among the distributed ledger nodes 4000 and then shares each rule.

As a result, transaction processing can be performed consistently between management organizations. For example, when the client node 2000 writes each TX to the plurality of management nodes 1000, it is possible to unify the presence/absence of integration of each TX and the content of the integration. Further, even when the plurality of client nodes 2000 corresponding to the respective management organizations exist, a TX consistent integration process can be performed between the respective management organizations. Also, regarding the relationship with the administrator of the management node 1000, the administrator only needs to set the information on one management node 1000 out of the plurality of management nodes 1000, and all the management nodes 1000 including the other management nodes 1000 can perform the integration of TX consistently.

In addition, each management node 1000 shares the key mapping table 1140 and stores it in the form of blockchain data. As a result, it is possible to correctly write the integrated and converted TX and read each business data (TX) thus written according to the unified rule among the plurality of management organizations.

Further, the distributed ledger node 4000 may share and store the key mapping table 1140. In this case, an item may be added to the key mapping table 1140 to set information that specifies the management node 1000 from which the TX having been used for creating the post-integration TX has been acquired.

As a result, each client node 2000 can read the appropriate business data corresponding to the written TX from the blockchain system 5000 regardless of management node 1000 through which the TX is written to the blockchain system 5000.

Hitherto, the embodiments for carrying out the invention have been specifically described. However, the invention is not limited to the above embodiments, and various changes can be made in a scope not departing from the spirit.

For example, in each embodiment, the information sharing assistance system 1 is a consortium type blockchain system, but it may be another form of blockchain system composed of specific members.

Further, at least one of the table and the module stored in the management node 1000 may be stored in the distributed ledger node 4000 or the client node 2000.

Further, in this embodiment, it is assumed that the types of TX to be integrated are the same, but different types of TX may be integrated. For example, a plurality of different processes performed in a series may be integrated.

Further, the integration of TX may be performed in parallel for each of the plurality of types, or only one type of TX may be integrated at the same time.

According to the description of this specification, at least the following will be apparent. That is, in the information sharing assistance system 1 of each embodiment, the information processing device (the management node 1000) determines whether a communication load in the information processing system exceeds a predetermined threshold in the integration management process. The new request may be created only when it is determined that the communication load exceeds the threshold.

As a result, when the blockchain system 5000 is overloaded and a significant improvement in throughput performance cannot be expected due to the integration process or the like of TX, the processing is not performed, so that the throughput performance can be stabilized.

Further, in the information sharing assistance system 1 of each embodiment, the information processing device may determine the types of the plurality of received requests in the integration management process, and the new requirement may be created only when the types satisfy a predetermined condition.

Thereby, for example, the throughput performance can be improved by performing the integration process only for the type of TX that can be expected to significantly improve the throughput performance by the integration.

Further, in the information sharing assistance system 1 of each embodiment, in a case of creating the new request in the integration management process, the information processing device may delete unnecessary information for a format with which each node of the information processing system can handle from among the plurality of received requests to create the new request.

In this way, in a case of integrating TX, by deleting unnecessary information from the pre-integration TX, the load on the system can be reduced and the throughput performance can be improved.

Further, in the information sharing assistance system 1 of each embodiment, in a case of integrating the plurality of requests in the integration management process, the information processing device may start creating the new request when determining that a predetermined time has elapsed from a time when a predetermined request is received among the plurality of received requests.

In this way, the number of TX to be integrated can be appropriately reduced by integrating TX after a predetermined period has elapsed from the time when the predetermined TX (for example, the first TX) is received. As a result, the throughput performance can be stabilized.

Further, in the information sharing assistance system 1 of each embodiment, in a case of integrating the plurality of requests in the integration management process, the information processing device may determine whether the number of the plurality of received requests exceeds a predetermined value, and start creating the new request when determining that the number exceeds the predetermined value.

In this way, by starting the integration of TX when the number of received TX becomes large, it is possible to prevent the number of requests related to TX to be integrated from becoming excessive. As a result, the throughput performance can be stabilized.

Further, in the information sharing assistance system 1 of each embodiment, the information processing device may receive a plurality of requests for writing predetermined information to each node of the information processing system in the request reception process, may create the new request related to writing based on the plurality of received requests in the integration management process, and may transmit the created new request to the information processing system to store a plurality of pieces of information related to the plurality of requests in each node of the information processing system in request process.

In this way, the management node 1000 creates the post-integration TX based on the plurality of received WriteTXs and transmits TX to the blockchain system 5000, so that the throughput performance related to transaction writing can be improved.

Further, in the information sharing assistance system 1 of each embodiment, the information processing device is used.

As the predetermined rule, information of an association between each of the plurality of received requests for writing and the new request may be stored. In the request reception process, a request for acquiring any one of respective pieces of information indicated by the plurality of requests for writing may be received from a predetermined device. A request conversion process may be executed in which the information is acquired from the plurality of pieces of information stored in the information processing system based on a predetermined acquisition request which is specified based on the stored associated information and associated with the new request corresponding to the received request for acquisition, and information containing the acquired target information is transmitted to the predetermined device.

In this way, when writing data by the post-integration TX (WriteTX) and then receiving ReadTX for some of the data, the management node 1000 creates the acquisition request (new ReadTX) corresponding to the post-integration TX by the key mapping table 1140, acquires some of the above data from the blockchain system 5000 by this acquisition request, and sends it to the client node 2000. As a result, even when the post-integration TX obtained by integrating a plurality of TXs is written to the blockchain system 5000, the business data related to the pre-integration TX can be correctly selected and read from the blockchain system 5000.

Further, in the information sharing assistance system 1 of each embodiment, each of the plurality of information processing devices may execute a policy sharing process of sharing and storing the predetermined rule.

As a result, even if there are a plurality of industry groups and there are a plurality of management nodes 1000, each management node 1000 can integrate TX consistently by the common rules (the integration condition module 1110, the integration policy table 1120, and the integration rule table 1130).

Further, in the information sharing assistance system 1 of each embodiment, each of the plurality of information processing devices may store information of an association between each of the plurality of received requests and a request after the plurality of requests are integrated as the predetermined rule. In the integration management process, each of the information processing devices may create the new request in which the plurality of received requests are associated according to the stored information.

In this way, the plurality of management nodes 1000 share the key mapping table 1140, which is the association information, and each management node 1000 creates a post-integration TX. Thus, each management node 1000 can consistently integrate TX even when there are the plurality of management nodes 1000 because there are a plurality of management organizations and the like, and business data can be correctly shared between respective management organizations.

What is claimed is:

1. An information sharing assistance method, executed by an information processing device, comprising:
a request reception process in which a plurality of predetermined requests are received, the plurality of predetermined requests being related to predetermined information for an information processing system in which the predetermined information is shared by a plurality of nodes that can communicate with each other;
an integration management process in which the plurality of received requests are converted and integrated into a format that can be handled by each node of the information processing system according to a predetermined rule, and thus a new request is created; and
a request process in which the new request is transmitted to the information processing system to process the predetermined request at each node of the information processing system.

2. The information sharing assistance method according to claim 1, wherein, in the integration management process, the information processing device determines whether a communication load in the information processing system exceeds a predetermined threshold, and creates the new request only when it is determined that the communication load exceeds the threshold.

3. The information sharing assistance method according to claim 1, wherein, in the integration management process, the information processing device determines types of the plurality of received requests, and creates the new request only in a case where the types satisfy a predetermined condition.

4. The information sharing assistance method according to claim 1, wherein, in a case of creating the new request in the integration management process, the information processing device deletes unnecessary information for a format with which each node of the information processing system can handle from among the plurality of received requests, and creates the new request.

5. The information sharing assistance method according to claim 1, wherein, in a case of integrating the plurality of requests in the integration management process, the information processing device starts creating the new request when determining that a predetermined time has elapsed from a time when a predetermined request is received among the plurality of receives requests.

6. The information sharing assistance method according to claim 5, wherein, in a case of integrating the plurality of requests in the integration management process, the information processing device determines whether the number of the plurality of received requests exceeds a predetermined value, and starts creating the new request when it is determined that the number exceeds the predetermined value.

7. The information sharing assistance method according to claim 1, wherein
the information processing device
in the request reception process, receives a plurality of requests for writing predetermined information to each node of the information processing system,
in the integration management process, creates the new request related to writing based on the plurality of received requests, and
in request process, transmits the created new request to the information processing system to store a plurality of pieces of information related to the plurality of requests in each node of the information processing system.

8. The information sharing assistance method according to claim 7, wherein
the information processing device
as the predetermined rule, stores information of an association between each of the plurality of received requests for writing and the new request,
in the request reception process, receives a request for acquiring any one of respective pieces of information indicated by the plurality of requests for writing from a predetermined device, and
executes a request conversion process in which the information is acquired from the plurality of pieces of information stored in the information processing system based on a predetermined acquisition request which is specified based on the stored associated information and associated with the new request corresponding to the received request for acquisition, and information containing the acquired target information is transmitted to the predetermined device.

9. The information sharing assistance method according to claim 1, wherein each of the plurality of information processing devices executes a policy sharing process in which the predetermined rule is shared and stored.

10. The information sharing assistance method according to claim 1, wherein
each of the plurality of information processing devices stores information of an association between each of the plurality of received requests and a request after the plurality of requests are integrated as the predetermined rule, and
in the integration management process, each of the information processing devices creates the new request in which the plurality of received requests are associated according to the stored information.

11. An information sharing assistance system, comprising:
an arithmetic device configured to perform
a request reception process in which a plurality of predetermined requests are received, the plurality of predetermined requests being related to predetermined information for an information processing system in which the predetermined information is shared by a plurality of nodes that can communicate with each other,
an integration management process in which the plurality of received requests are converted and integrated into a format that can be handled by each node of the information processing system according to a predetermined rule and thus a new request is created, and
a request process in which the new request is transmitted to the information processing system to process the predetermined request at each node of the information processing system.
